(19) United States
(12) Patent Application Publication
(10) Pub. No.: US 2008/0202352 A1
(43) Pub. Date: Aug. 28, 2008

(54) Microwave Oven and Apparatus for Preparing Ready-to-Eat Hot Meals Including Said Microwave Oven

(75) Inventors: Sergio Comito, Parma (IT); Sergio Veronesi, Basilicanova (Parma) (IT); Oreste Caselli, Bibbiano (Reggio Emilia) (IT); Gabriele Lusignani, Fidenza (Parma) (IT)

Correspondence Address: AKERMAN SENTERFITT, P.O. BOX 3188, WEST PALM BEACH, FL, 33402-3188, US

(73) Assignee: Barilla G. e. R. Fratelli S.p.A., Parma (IT)

(21) Appl. No.: 12/038,046

(22) Filed: Feb. 27, 2008

(30) Foreign Application Priority Data
Feb. 27, 2007 (EP) 07425105.9

(51) Int. Cl. F24C 11/00; H05B 6/64; H05B 6/80; F24C 7/02

(52) U.S. Cl. 99/339; 219/756

(57) ABSTRACT

The present invention regards a microwave oven (1) of the type having a height lower than width comprising a cooking chamber (3) having a support surface (12) for a food product, a microwave source (8) and means (10) for sending the microwaves from said source (8) into the cooking chamber (3), characterised in that said support surface is formed by a dielectric material having a dielectric constant ∈′ in the range of 1-9 and a loss factor ∈″ less than 0.01 at the frequency of 2450 MHz. The present invention also regards an apparatus (30) for preparing ready-to-eat meals comprising a pasta cooker and a microwave oven (1) of the aforesaid type.

### FIELD OF APPLICATION

In its most general aspect, the present invention refers to the food industry and catering sector.

In particular, the invention refers to a microwave oven and to an apparatus including said microwave oven for preparing ready-to-eat meals, preferably pasta-based meals, in the context of catering services such as for example cafés, small restaurants and fast food places.

### PRIOR ART

Different types of microwave ovens are known in the art which permit cooking or defrosting foods in a more rapid manner with respect to conventional heat ovens. In particular, in the context of preparing pasta-based ready-to-eat meals in catering services, such microwave ovens have a wide application for heating or defrosting precooked and frozen pasta and/or frozen sauces.

Conventional microwave ovens comprise a cooking chamber (technically called cavity) having a support surface for the food product to be cooked, heated or defrosted, a microwave source (normally a magnetron), a waveguide for sending the microwaves generated in the cooking chamber as well as a suitable electronic control and power supply circuit of the magnetron.

One fundamental aspect of the microwave ovens is that of ensuring a good uniformity of cooking of the food product or food set therein, so to avoid burning or surface browning on the cooked food product.

To this end, it is known that in order to ensure a good uniformity of cooking, the microwave ovens must firstly satisfy specific size characteristics, in particular high width/height ratios, so to have an adequate volume for the distribution of the microwaves on the food product to be cooked. In addition, appropriate stirring systems or movable metal parts can be inserted in the cooking chamber for modifying the field formed by the microwaves—which is very complex, causing microwave reflection from the cooking chamber walls—so as to obtain a greater concentration of the microwaves on the food product.

Nevertheless, the aforesaid microwave ovens are inconvenient to use in refreshments rooms such as cafés, small restaurants, fast food places etc. since due to their large size they tend to occupy most of the work counter where they are installed, thus limiting the available space for other machines and workers.

Such drawback is particularly felt in the context of preparing pasta-based ready-to-eat meals, since the dining establishments often employ two separate machines for this purpose, i.e. one large-size machine for cooking the pasta (for example dried or precooked and frozen pasta) and a microwave of the aforesaid type for cooking/heating the seasonings (i.e. sauces), in order to offer a first course dish which best meets the expectations of the final consumer, i.e. a first course dish having organoleptic characteristics comparable with those of a corresponding dish made at home.

For such dining establishments, it would be desirable to have available machines for preparing pasta-based first course dishes with smaller dimensions, in particular a microwave oven with particularly reduced dimensions, keeping in mind the need to ensure an adequate cooking uniformity for the foods or food products cooked therein.

The U.S. Pat. No. 5,272,302 describes a microwave oven having a cooking chamber of reduced height (lower than its width) equipped on its upper part with a layer of material absorbing the microwaves and on its lower part with an electric cooking plate, on which the food product is set and in which a plurality of Calrod heating elements are buried.

Such microwave oven lends itself to being employed for the cooking of reduced-size products, such as pizzas and pies, attaining a substantially cooking uniformity on them.

Nevertheless, said microwave oven is structurally complicated and costly to make.

Moreover, the heating of the food product is mainly operated from the electric cooking plate (and possible also by convection air introduced in the cooking chamber and made to pass in close proximity to the lower surface of the cooking plate) while the microwaves appear simply to contribute to the acceleration of the heating, avoiding at the same time an excessive cooking of the edges of the food product due to the absorption of the reflected microwaves by the absorbing material arranged on the top of the cooking chamber.

This leads to high operation costs, due in particular to the high electrical energy consumption by the heating plate.

The technical problem underlying the present invention is therefore that of making available a microwave oven for cooking and/or defrosting food products, which has reduced size and is capable of ensuring an adequate cooking uniformity without having the drawbacks previously mentioned with reference to the prior art.

### SUMMARY OF THE INVENTION

Such technical problem is resolved by a microwave of the type having a lower height than width comprising a cooking chamber with support surface for a food product, a microwave source and means for sending the microwaves generated by said source in the cooking chamber, wherein the support surface is formed by a dielectric material having a dielectric constant ∈′ in the range of 1-9 and a loss factor ∈″ less than 0.01 at the frequency of 2450 MHz.

In other words, the dielectric material forming support surface of the microwave oven according to the invention has a loss factor or dissipation factor, so-called delta tangent (tan δ), less than 0.02 at the frequency of 2450 MHz, said delta tangent being defined by the ratio between ∈″ and ∈′.

The aforesaid dielectric constant ∈′ and loss factor ∈″ parameters as well as the delta tangent preferably refer to test measurements carried out at the frequency of 2450 MHz, according to the provision DIN53843.

Preferably, said dielectric material has a dielectric constant ∈′ in the range of 2-4 and a loss factor ∈″ less than 0.01 at the frequency of 2450 MHz.

Preferably, said dielectric material is a material chosen from the group comprising ceramic materials, glass-ceramics and glassy materials loaded or doped with metal oxides.

Preferably, the microwave oven of the present invention has a height of not greater than 15 cm.

Surprisingly, it was found that with the microwave oven of reduced size according to the invention, a cooking uniformity is attained on the food product without resorting to the aid of heating plates, as taught by the prior art.

More in particular, from experimental tests conducted by the Applicant, it was found that the dielectric material forming the food product support surface is poorly absorbent of the microwaves (it does not function, therefore, as a supplementary heating element), while instead it accomplishes a double task: on the one hand it alters the electromagnetic field induced by the microwaves by distributing it over an extended area near the bottom of the food product and, on the other hand, it provides good heat insulation, adapted to maintain the heat generated by the absorption of the microwaves by the food product near the bottom thereof.

A homogenous distribution of the microwaves on the food product is thereby obtained, which is advantageously translated into a cooking uniformity of said food product without excessive heating or surface browning.

The aforesaid technical problem is also solved by an integrated apparatus for preparing ready-to-eat meals, in particular, pasta-based ready-to-eat meals comprising a pasta-cooker and a microwave oven of the aforesaid type.

More in particular, and in accordance with one aspect of the present invention, the aforesaid apparatus for preparing ready-to-eat meals comprises at least one basket adapted to receive pre-established amounts of pasta to be cooked, a cooking tank containing water heated by heating means and a microwave oven for the heating of suitable seasonings of the type having a lower height than width and comprising a cooking chamber having a support surface for a food product, characterised in that said support surface is formed by a dielectric material having a dielectric constant ∈′ in the range of 1-9 and a loss factor ∈″ less than 0.01 at the frequency of 2450 MHz.

The aforesaid microwave oven moreover comprises a microwave source (magnetron) and means for sending the microwaves generated by said source into the cooking chamber. Advantageously, said means for sending the microwaves into the cooking chamber are formed by a waveguide in communication with the microwave source and the cooking chamber.

Preferably, in the apparatus for preparing ready-to-eat meals according to the invention, said microwave oven is arranged in a suitable space under said cooking tank and is integral therewith.

In accordance with one aspect of the present invention, the waveguide has a substantially T shape, i.e. it comprises a portion extended longitudinally from the magnetron towards the cooking chamber, and a portion transversely extended (i.e. in the direction of the oven width) on the cooking chamber and in communication with the latter.

With the term “cooking” it is intended, in the most general manner, the pasta heating operation (for example dried or pre-cooked and frozen pasta) carried out in the cooking tank of the machine, so to bring said pasta to the optimal cooked conditions for immediate consumption. Such heating operation can lead to an actual cooking of the pasta, if the latter is for example in dry state or was originally precooked or frozen without reaching the optimal cooked conditions for consumption or simply a “revival” for example in the case of pre-cooked pasta frozen already at optimal cooked conditions for immediate consumption.

The characteristics and advantages of the microwave oven and apparatus for preparing ready-to-eat meals according to the present invention will be clearer from the following description of a preferred embodiment thereof, said description being provided as illustrative and non-limiting with reference to the drawings herein attached.

### BRIEF DESCRIPTION OF THE DRAWINGS

In the figures:

FIG. 1 shows a perspective view of a microwave, oven of reduced size according to the present invention.

FIG. 2 shows a front view of the microwave oven of FIG. 1,

FIG. 3 shows a lateral view of the microwave oven of FIG. 1,

FIG. 4 shows a top view of the microwave oven of FIG. 1,

FIG. 5 shows a longitudinal section view of the microwave oven of FIG. 1,

FIG. 6 shows a cross section view of the microwave oven of FIG. 1 at the cooking chamber of said oven,

FIG. 7 shows a section plane, perspective view of an apparatus according to the invention for preparing ready-to-eat meals including the microwave of FIG. 1,

FIG. 8 shows a detail of the apparatus of FIG. 7,

FIGS. 9 and 10 show further views of parts of the apparatus of FIG. 7.

### DETAILED DESCRIPTION OF PREFERRED EMBODIMENTS

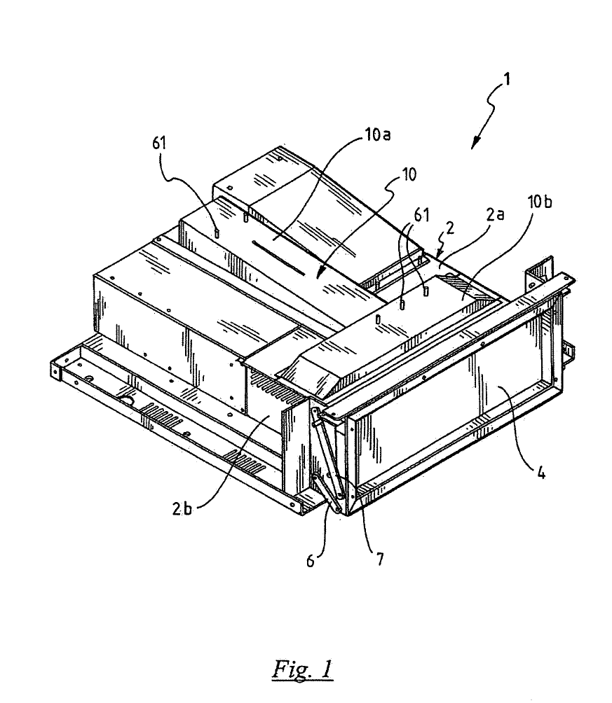

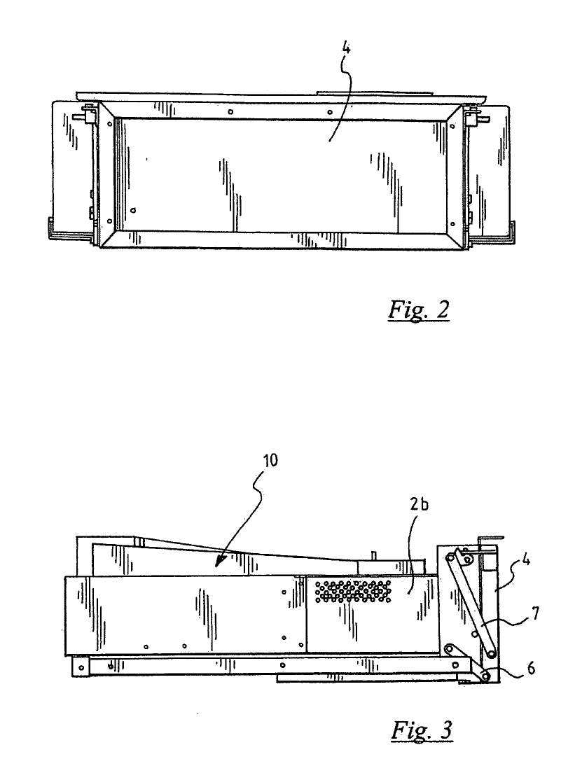

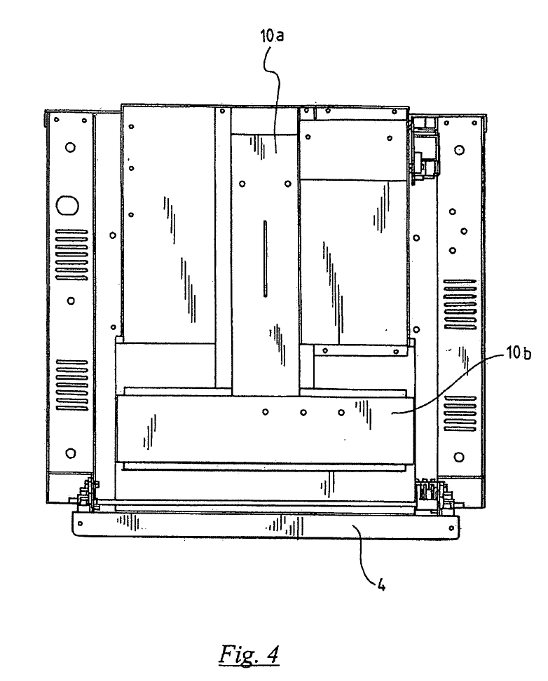

With reference to FIGS. 1-6, a microwave oven according to the invention is indicated in its entirety with 1.

The microwave oven 1 comprises a frame 2 at whose interior a cooking/heating chamber 3 is defined for a food product.

In particular, the cooking chamber 3 is defined by an upper wall 2a, by side walls 2b, by a rear wall 2d and by a lower wall 2c of the frame 2 and is accessible from the outside on the front by means of a door 4.

The door 4 is connected to the frame 2 by means of pairs of arms 6 and 7 hinged to the frame 2 and on the respective lateral edges of the door 4. In such a manner, the door 4 is movable between a closed position in which it is in abutment against the frame 2 so to close the cooking chamber 3 and open positions in which it is spaced from the cooking chamber 3, thus to make it accessible from the outside.

Advantageously, in the maximum opening position, the door 4 constitutes a support surface, for example for containers containing the food products to be cooked or heated, as an extension of the support surface for said containers (which will be described below) which is found inside the cooking chamber 3.

The microwave oven 1 moreover comprises, inside the frame 2 and behind the cooking/heating chamber 3, a microwave source composed of a magnetron 8 (for example having a power of 1 Kw) connected to an appropriate transformer 9.

The microwave oven 1 moreover comprises means for sending the microwaves generated by the magnetron 8 into the cooking chamber 3, said means being composed of a waveguide 10 arranged on the upper wall 2a of the frame 2.

More in particular and in accordance with one aspect of the present invention, the waveguide 10 has a substantially T conformation, i.e. it comprises a portion 10a longitudinally extended on the frame 2 from the magnetron 8 towards the cooking chamber 3, and a portion 10b extended transversely (i.e. in the direction of the oven 1 width) on the cooking chamber 3 and in communication with the latter by means of opposing openings 11.

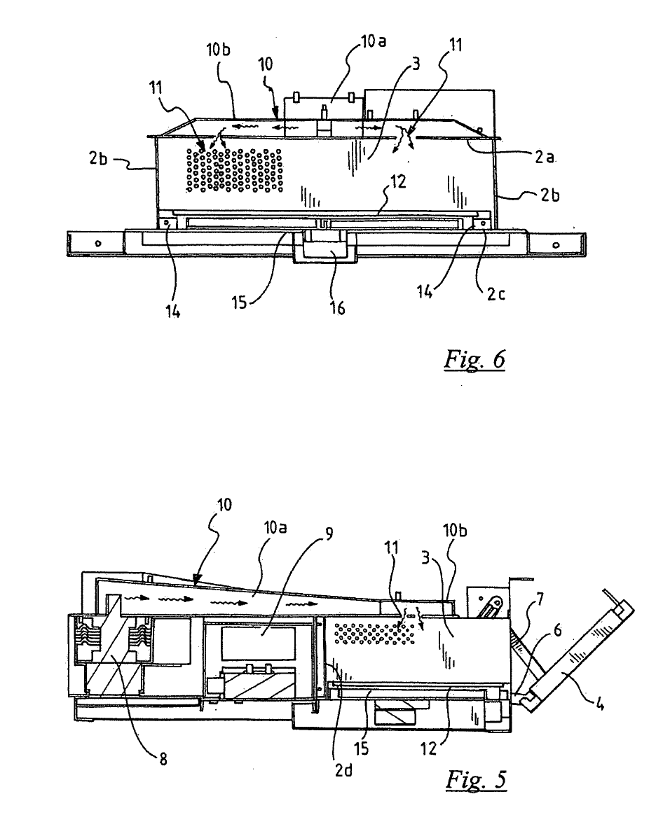

Therefore, as indicated with the arrows in FIGS. 5 and 6, the microwaves generated by the magnetron 8 run through the longitudinal portion 10a of the waveguide 10 until they reach the transverse portion 10b of the waveguide 10 where they are divided into two opposing flows, which are inserted in the cooking chamber 3 by means of the openings 11.

This advantageously contributes to obtain an improved distribution of the microwaves inside the cooking chamber 3.

In accordance with the present invention, a support surface 12 is provided in the cooking chamber 3 for a food product to be cooked or heated, possibly contained in a suitable container, said support surface 12 being formed of a dielectric material having a dielectric constant ∈′ in the range of 1-9 and a loss factor ∈″ less than 0.01 at the frequency of 2450 MHz.

Preferably, said dielectric material is a material chosen from the group comprising ceramic materials, glass ceramics, glassy materials loaded or doped with metal oxides.

The support surface 12 is arranged near the lower wall 2c (bottom) of the cooking chamber and spaced from it by means of opposing support feet 14, preferably made of a plastic material which is substantially transparent to microwaves, such as Teflon, polypropylene etc.

Between the support plane 12 and the bottom 12c of the cooking chamber, a stirrer 15 is also provided, controlled by a motor 16, which contributes to obtain a greater distribution of the microwaves near the food product to be cooked and/or heated.

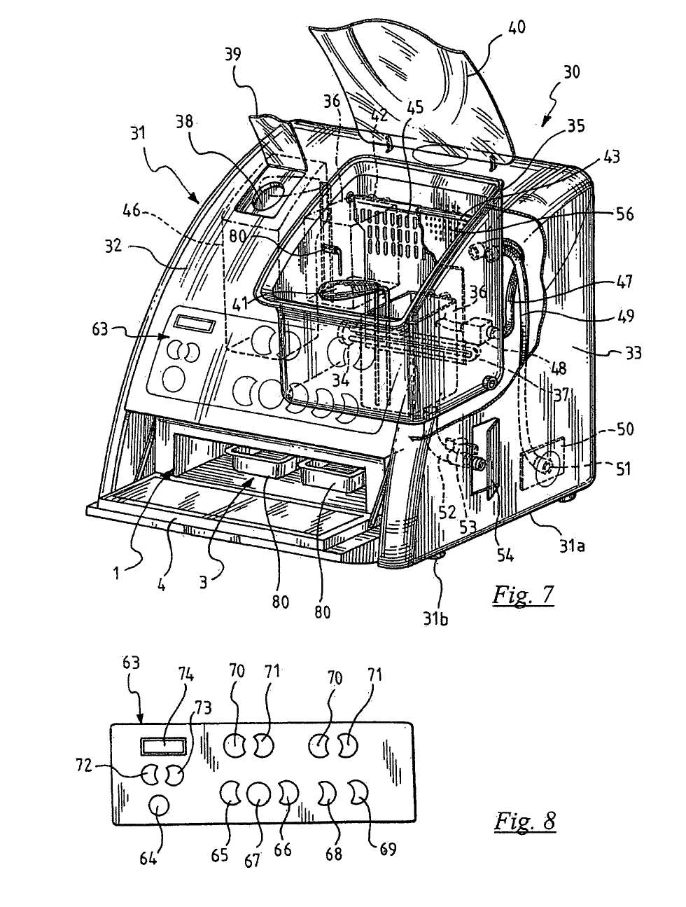

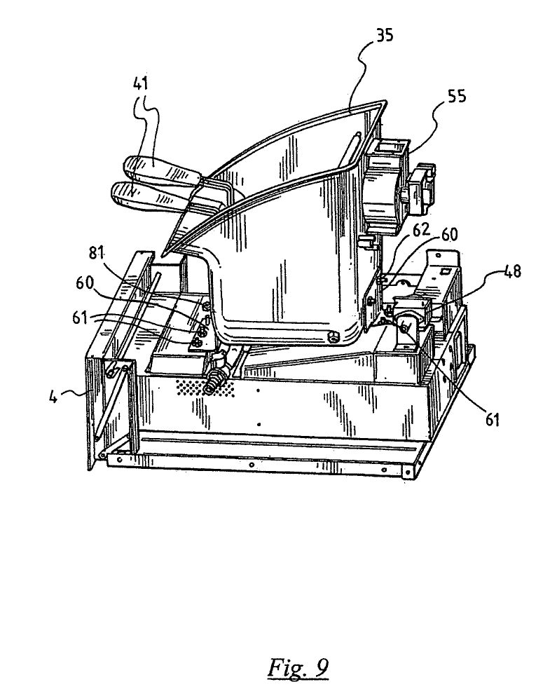

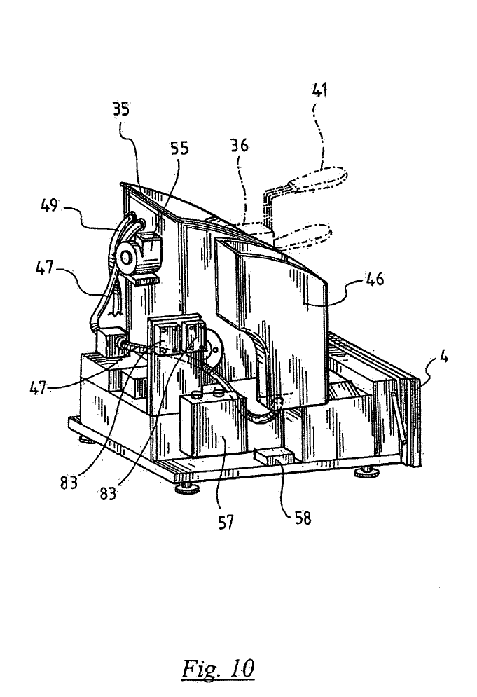

With reference now to FIGS. 7-10, an apparatus according to the invention for the preparation of ready-to-eat dishes is shown in its entirety with the reference number 30.

It comprises a box-shaped body 31 having a bottom 31a, a curved front wall 32, lateral walls 33 and a rear Wall (not shown). A plurality of anti-slip feet 31b is arranged on the bottom 31a for levelling the apparatus 30.

The box-shaped body 31 can be manufactured in a metal material or preferably in an appropriate plastic material such as for example ABS (copolymer obtained by the polymerisation of acrylonitrile butadiene and styrene).

Different components of the apparatus 30 are housed and supported in the box body 31 which are described below.

In particular, the apparatus 30 comprises, in an upper part of the box body 31, a cooking tank 35 for containing heated water necessary for the cooking or “revival” of pasta to the optimal conditions for immediate consumption and two perforated baskets 36 which, in use, are destined to contain pre-established amounts of pasta to be cooked, and to be inserted in the heated water of the tank 35 for the cooking of said pasta.

The apparatus 30 is moreover equipped with appropriate heating means of the water contained in the cooking tank 35. In the present example, such means are two independent electric resistances 37 inserted in the cooking tank 35 near the bottom thereof and spaced from said bottom. In particular, the electric resistances 37 are supported by an appropriate flange 34 fixed to a side wall of the cooking tank 35. It should be noted, moreover, that the cooking tank 35 is provided with a perforated plate 45 for protecting the electric resistances from accidental impact, in particular deriving from the insertion of perforated baskets 36 in the tank 35 during the operating steps of use of the apparatus 30.

Inside the cooking tank 35, a probe 80 is provided for the level of the heated water, while the cooking tank 35 is accessible from the outside through a cover 40 hinged on the front wall 32 of the apparatus 30, so as to be able to rotate between a closed position and open positions. Advantageously, the apparatus 30 is equipped with a locking system, of per se conventional type, for the cover 40 in its maximum opening position. During a cooking cycle, the cover 40 lies in its closed position so to protect the operator from vapours (essentially steam) generated inside the tank 35 during the cooking of the pasta.

The perforated baskets 36 are advantageously equipped with a respective handle 41 which permits facilitating the manual extraction of the perforated baskets 36 from the cooking tank 35, when the pasta cooking has been completed, as well as the insertion of the baskets 36 in the aforesaid tank 35 to begin a new cooking cycle. Moreover, advantageously, the perforated baskets 36 are supported in a removable manner inside the cooking tank 35 between a lowered operative cooking position and a raised cooking-completed position. In particular, regarding the support in the raised position, each perforated basket 36 is provided with a hook 42, situated on the part opposite the respective handle 41, which is engaged on a bar 43 arranged on the upper part of the cooking tank 35.

Preferably, the perforated baskets 36 are made of stainless steel, while the handles 41 are made of a suitable plastic material, such as ABS.

The apparatus 30 moreover comprises a container 46 arranged in a position flanking the cooking tank 35 and in fluid communication with the latter through a connection duct 47. The container 46 is also in fluid communication with the outside of the apparatus by means of an appropriate duct (not shown) terminating on its upper part in an opening 38 provided on the front wall 32 of the apparatus 30. In particular, such opening 38 is accessible from the outside through a cover 39 hinged on the front wall 32 of the apparatus 30. Preferably, the apparatus 30 is also equipped with a locking system, per se conventional, for the cover 39 in its maximum opening position.

The container 46 is loaded with supplementary water which is advantageously sent to the cooking tank 35 for restoring the amount of water lost by evaporation by the cooking tank 35 during the functioning of the apparatus 30.

To such end, a pump 48 is provided on the connection duct 47, which draws water from the container 46 and discharges it in the cooking tank 35 as a function of the water level in the cooking tank 35 determined by the probe 80.

Regarding the supply of cooking water to the tank 35, a duct 49 is provided in the apparatus 30 for placing the cooking tank 35 in fluid communication with a water supply source outside the apparatus 30, which can be a normal water supply system.

To such end, the duct 49 is advantageously accessible from the outside through a removable knob 50 provided on one lateral wall 33 of the apparatus 30, so to be able to be placed in connection with a water-load tube (not shown) coming for example from the water supply system.

An electric valve 51 is also provided for allowing or blocking the access of water coming from the water supply network and directed towards the cooking, tank 35. The apparatus 30 moreover comprises a safety sensor 58 in communication with the cooking tank 35 for controlling the temperature of the heated water.

The discharge of the cooking water of the tank 35 is instead attained by means of a duct 52 in fluid communication with the bottom of the tank 35 and terminating with a tap 53 accessible from the outside through a door 54 provided on a side wall 33 of the apparatus 30.

The tap 53 can be connected to an attachment connector of a discharge tube (not shown) for facilitating the discharge of the cooking water into an appropriate container, for example an appropriate tank, after a predetermined number of cooking cycles.

The apparatus 30 is moreover equipped with a ventilator 55 in communication with the cooking tank 35 for the extraction of the vapour which develops from the water heated in the cooking tank 35. In particular, such vapour is directed by forced convection through a grid of holes 56 provided on the rear wall of the cooking tank 35 and through the ventilator 55 so to then be possibly collected or expelled from the apparatus 30 through an appropriate vent pipe.

The apparatus 30 moreover comprises, below the cooking tank 35, a housing space for a microwave oven 1 of the above-described type. Such microwave oven 1, once inserted in the aforesaid space, is fixed to the cooking tank 35 by means of brackets 60 provided with holes for the passage of pins 61 and 62 formed integrally on the waveguide 10 of the oven 1 and outside the cooking tank 35. Appropriate fixing nuts 81 in engagement with the pins 61 and 62 ensure an adequate locking in position of the microwave oven 1.

The apparatus 30 is moreover equipped with a unit 57 which includes the electrical and/or electronic components for the command and control of the apparatus 30 functioning, as well as a panel 63 comprising a lower or upper group of switches. In particular, the lower group of switches comprises a general on or off switch 64 of the apparatus 30 and in particular of the electric resistances 37, two switches 65 and 66 for the turning on and subsequent turning off, after a pre-established time, of the microwave source (magnetron) to permit the heating of seasonings (i.e. sauces) for the pasta contained in a single tub and in two separate tubs respectively inserted in the cooking chamber 3 of the microwave oven 1, a switch 67 for the turning on and subsequent turning off, after a pre-established time, of the microwave source (magnetron) to permit the heating of a precooked pasta-based ready-to-eat meal and two switches 68 and 69 for the turning on and subsequent turning off, after a pre-established time, of the microwave source (magnetron) to permit the quick defrosting of seasonings (i.e. sauces) for the pasta contained for example, in a single tub 80 and in two separate tubs 80 respectively inserted in the cooking chamber 3 of the microwave 1.

The upper group of switches instead comprises two pairs of switches 70 and 71, a pair for each perforated basket 36, in which each switch 70 or 71 drives a timer associated with a respective basket 36 according to a pre-established cooking time.

The cooking time of the pasta, as with the activation time of the microwave source, can also be manually regulated through respective increase and decrease buttons 72 and 73.

The functioning state of the apparatus 30 deriving from the activation of one or more of the aforesaid switches can be advantageously visualised through an LED display 74 (LEDs not shown).

Regarding the functioning of the above-described apparatus 30, it should be: said that it is first necessary to fill with water the cooking tank 35 and the tank 46 for supplementary water.

For such purpose, the cooking tank 35 can be placed in communication with the water supply system through the duct 52, so to fill the aforesaid tank 35 up to the desired level, while the feeding of water to the container 46 occurs by opening the cover 39 and inserting water from the opening 38 on the front wall 32 of the apparatus 30. At the end of the filling with water, the cover 39 is repositioned in closed position.

Subsequently, energy is provided to the electric resistances 37 so to heat the water contained in the cooking tank 35 to the work temperature (about 98° C.). The safety sensor 58 automatically interrupts the supply of energy to the electric resistances 77 as soon as the water has reached the work temperature and restore said supply when the water falls below the work temperature.

At this point the apparatus 30 is ready for use both as pasta cooker and microwave oven.

Regarding use as pasta cooker, the pasta to be cooked is loaded in pre-established amounts in the perforated baskets 36 (or possible in only one of these) and said baskets are then manually inserted in the cooking tank 35. At this point, the cooking chamber 35 is closed with the related cover 80 and the pre-established cooking temperature is activated by means of one of the switches 70 and 71 for each perforated basket 36.

After the pre-established cooking time, the baskets 36 are manually extracted from the tank 35 and advantageously coupled by means of the hooks 42 on the bar 43 of the cooking tank 35, so to permit the draining of the cooking water. The cooked pasta is then poured into an appropriate container, for example a dish, for the final consumer.

A fixed or flashing LED or a sound system can be provided for indicating the end of the cooking cycle.

At this point, after having discharged the cooking water, the pasta cooker of the apparatus 30 can be utilised for a new cooking cycle, repeating the above-indicated operations.

Regarding the functioning of the microwave oven, the operator can advantageously prearrange the heating of the seasonings (i.e. sauces) to be associated with the pasta cooked in the pasta cooker, as indicated above, by inserting said seasonings, contained in appropriate tubs (in the example two tubs 88 are shown), in the cooking chamber 3 of the microwave oven 1 and then activating the microwave source for a pre-established time through one of the switches 65 and 66 according to need.

It should be noted that, according to a further aspect of the present invention, the apparatus 30 is equipped with a device capable of modulating the power supply to the pasta cooker when the microwave oven is in function, so to not exceed a pre-established power threshold, preferably 3 kW, which is critical in many commercial establishments. In particular, the supply to the pasta cooker is automatically reduced when the microwave oven is in function, since the latter absorbs a lot of power.

More in particular, said device is formed by a pair of relays 83 in communication with the unit 57 and the electric resistances 37 so to deactivate one of the electric resistances 37 when the microwave oven 1 is in function. Advantageously, the electric resistances 37 are alternately deactivated between successive functioning cycles of the microwave oven 1, so to ensure a substantial uniformity of the electric resistances 37.

In addition to the abovementioned advantages, it should be noted that the apparatus according to the invention is particularly compact, due to the reduced dimensions of the microwave oven, so to occupy little space in food service business settings and advantageously is capable of integrating the functions of pasta cooker and microwave oven in a single machine, instead of two separate machines as in the prior art.

A further advantage of the apparatus according to the invention lies in the manufacturing simplicity and ease of use as pasta cooker and microwave oven even by not particularly expert personnel.

A man skilled in the art can make numerous modifications and variants to the above-described apparatus and oven, all coming within the protective scope of the attached claims.

We claim:

1. Microwave oven of the type having a height lower than width comprising a cooking chamber having a support surface for a food product, a microwave source and means for sending the microwaves generated by the microwave source into the cooking chamber, wherein said support surface is formed by a dielectric material having a dielectric constant ∈′ in the range of 1-9 and a loss factor ∈″ less than 0.01 at the frequency of 2450 MHz.

2. Microwave oven according to claim 1, wherein the dielectric material forming the support surface has a loss factor and dissipation factor (tan δ) less than 0.02 at the frequency of 2450 MHz.

3. Microwave oven according to claim 1, wherein the dielectric material has a dielectric constant ∈′ in the range, of 2-4 and a loss factor ∈″ less than 0.01 at the frequency of 2450 MHz.

4. Microwave oven according to claim 1 wherein the dielectric material is a material chosen from the group comprising ceramic materials, glass ceramics and glassy materials loaded or doped with metal oxides.

5. Microwave oven according to claim 1 having a height not greater than 15 cm.

6. Microwave oven according to claim 1, wherein the microwave source consists of a magnetron and the means for sending the microwaves in the cooking chamber consists of waveguide in communication with the magnetron and the cooking chamber.

7. Microwave oven according to claim 6, wherein the waveguide has a substantially T conformation and comprises a first portion extended longitudinally from the magnetron towards the cooking chamber and a second portion extended transversely on the cooking chamber and in communication with the latter.

8. Microwave oven according, to claim 1 wherein the support surface is arranged near the bottom of the cooking chamber and is spaced from it by means of opposite support feet formed of a plastic material which is substantially transparent to microwaves.

9. Microwave oven according to claim 8, further comprising a stirrer arranged between the support surface and the bottom of the cooking chamber.

10. Apparatus for preparing ready-to-eat meals comprising a pasta cooker and a microwave oven according to claim 1.

11. Apparatus for preparing ready-to-eat meals comprising at least one basket adapted to receive pre-established amounts of pasta to be cooked, a cooking tank containing water heated by heating means and a microwave oven for heating appropriate seasonings according to any one of the claim 1.

12. Apparatus (30) for preparing ready-to-eat meals according to claim 11, wherein the microwave oven is arranged in a suitable space below the cooking tank and is integral therewith.

13. Apparatus according to claim 11, wherein the heating means comprise a pair of independent electric resistances inserted in the cooking tank near its bottom and at a distance from said bottom.

14. Apparatus according to claim 13, wherein the cooking tank is provided with a perforated plate for protecting the electric resistances from accidental impact.

15. Apparatus according to claim 11 wherein each perforated basket is equipped with a handle and an opposite hook for supporting the perforated basket in a raised position in the cooking tank by means of coupling on a corresponding bar arranged on the upper part of the cooking tank.

16. Apparatus according to claim 11, further comprising a container for supplementary water arranged in a position flanking the cooking tank and in fluid communication with the latter through a connection duct.

17. Apparatus according to claim 11, further comprising a command and control unit.

18. Apparatus according to claim 17, further comprising means for modulating the power supply when the microwave oven is in function.

19. Apparatus according to claim 18, wherein the means for modulating the power supply comprise a pair of relays in communication with the command and control unit and with the electric resistances so to deactivate one of the electric resistances when the microwave oven is in function.

20. Apparatus according to claim 19, wherein the relays are operated so to alternately deactivate the electric resistances between successive operating cycles of the microwave oven.
